(19) United States
(12) Patent Application Publication
(10) Pub. No.: US 2015/0194827 A1
(43) Pub. Date: Jul. 9, 2015

(54) INFORMATION PROCESSING DEVICE INCLUDING BATTERY AND CHARGING METHOD OF BATTERY

(71) Applicant: FUJITSU LIMITED, Kawasaki-shi (JP)

(72) Inventor: YUICHI SAKAGAMI, Sagamihara (JP)

(21) Appl. No.: 14/665,320

(22) Filed: Mar. 23, 2015

Related U.S. Application Data
(63) Continuation of application No. PCT/JP2012/074804, filed on Sep. 26, 2012.

(51) Int. Cl. H02J 7/00

(52) U.S. Cl. CPC H02J 7/0021

(57) ABSTRACT

Batteries, a power source that charges the batteries, a sensor that obtains a quantity of charge of each battery and a total sum of the quantities of charge of the batteries, and a processor are provided in an information processing device. The processor determines a charging candidate battery and the number of charging candidate batteries on the basis of the quantity of charge of each battery and the total sum of the quantities of charge of the batteries, determines a set of a target battery and charging power so that the charging candidate battery is charged by using the charging power that is one of a value obtained by dividing maximum suppliable power by the number of charging candidate batteries, and maximum receivable power, whichever is smaller, and controls the target battery to be charged by the charging power by using the power source.

### CROSS-REFERENCE TO RELATED APPLICATION

This application is a continuation application of International Application PCT/JP2012/074804 filed on Sep. 26, 2012 and designated the U.S., the entire contents of which are incorporated herein by reference.

### FIELD

The embodiments discussed herein are related to an information processing device including a battery and a charging method of a battery.

### BACKGROUND

In recent years, there has been a tendency for information processing devices to be requested to have a high performance and high reliability. Various techniques to back up the power source have been developed to prevent the supply of power to the information processing device from being cut off due to a temporary power failure of the commercial power source.

In particular, a storage device for saving a large capacity of data is caused to continue its operation in order to prevent data stored in a hard disk drive and data stored in a volatile memory such as a cache memory from being erased even if the commercial power source temporarily fails because a battery begins to operate when the supply of power from the external power source is stopped at the time of a power failure. In such a battery, the value of the charging current is set so as to have a certain fixed value.

As one safety measure, there is a case where a plurality of batteries is provided in one information processing device. In such an information processing device, on the assumption that all of the mounted batteries are charged at the same time, the value of the charging current is set so as not to exceed a maximum charging current that is determined from the value of a current that each battery can receive.

As an example of the power source backup technique, a charging device is known that reduces the charging current by determining that the battery is fully charged when the battery voltage becomes a predetermined voltage or higher. Then, a charging method is known for simultaneously charging a plurality of batteries in the state of being connected in parallel. In this charging method, the number of connected batteries is detected, the charging conditions of the batteries are set in accordance with the detected number of batteries, the charging control is performed on the basis of the charging conditions, and when the change in the number of connected batteries is detected during the charging of the batteries, the battery charging control is initialized and the charging conditions are set again.

As another example of the power source backup technique, a device is known for charging a plurality of batteries in parallel. This device has a unit configured to detect a difference between a maximum allowable charging current that is allowed by a battery and a charging current that flows into the plurality of batteries as a first difference value, a unit configured to detect a difference between a maximum producible charging current that a charging circuit can produce and a charging current that flows out of the charging circuit as a second difference value, and a control unit configured to control the charging circuit to produce a maximum charging current in accordance with the first and second difference values in a range where the charging current that flows into each battery does not exceed the maximum allowable charging current and the charging current that the charging circuit produces does not exceed the maximum producible charging current.
Patent Document 1: Japanese Laid-open Patent Publication No. 11-069644
Patent Document 2: Japanese Laid-open Patent Publication No. 08-182213

### SUMMARY

According to an aspect of the embodiments, an information processing device includes a plurality of batteries, a power source that charges the plurality of batteries, a sensor that obtains a quantity of charge of each of the plurality of batteries and the total sum of the quantities of charge of the plurality of batteries, and a processor.

The processor determines a charging candidate battery, which is a battery that needs charging, from among the plurality of batteries, and the number of charging candidate batteries on the basis of the quantity of charge of each of the plurality of batteries and the total sum of the quantities of charge of the plurality of batteries, both of which are obtained by the sensor, determines a set of a target battery that is a battery to be charged and charging power so that the charging candidate battery is charged by using one of a value obtained by dividing maximum suppliable power which the power source can supply by the number of charging candidate batteries, and maximum receivable power which the charging candidate battery can receive, whichever is smaller, as the charging power, and controls the determined target battery to be charged by the charging power by using the power source.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an outline of a storage device;

FIG. 2 is an example of a function block diagram of the storage device;

FIG. 3 is an example of a device configuration diagram of the storage device;

FIG. 4 is an example of a device configuration diagram of a battery unit of the storage device in FIG. 2;

FIG. 5A is a flowchart (part 1) illustrating processing of an embodiment of a charging method;

FIG. 5B is a flowchart (part 2) illustrating the processing of the embodiment of the charging method;

FIG. 6A is a diagram (part 1) illustrating an example of processing of an embodiment of a charging method;

FIG. 6B is a diagram (part 2) illustrating the example of the processing of the embodiment of the charging method; and

FIG. 7 is a diagram illustrating an example of processing of another embodiment of a charging method.

### DESCRIPTION OF EMBODIMENTS

As described previously, in the case where it is supposed that all of the batteries mounted in an information processing device are charged simultaneously, the value of a charging current is set so as not to exceed a maximum charging current that is determined from a charging current that each battery can receive. In the case where the setting is performed as described above, even if in practice only some of the batteries need to be charged, it takes the same charging time as that in the case where all of the batteries are charged.

For example, in an information processing device such as a storage device for which a high reliability is requested, even in the case where a few batteries, which is a portion of all of the batteries, are replaced with new ones and then the new batteries are charged, there is a problem such that it takes a long charging time.

For example, a case is supposed where in an information processing device in which four batteries are mounted, the state of charge of all of the batteries is 0% and it takes two hours to simultaneously charge all of the batteries from the state where the state of charge is 0% to the fully charged state. In this case, if only one of the batteries has a state of charge of 0% and the other three batteries are in the fully charged state, it takes two hours to charge the one battery that is not fully charged to the fully charged state as a result.

Further, because the charging current of the battery is designed as a fixed value, the value of the charging current when charging all of the batteries is a value that is lower than the value of a maximum current that the power source can supply, and therefore, there is a problem such that a reduction in the charging time is impeded.

Hereinafter, embodiments are explained with reference to the drawings. In the drawings, the same or similar reference symbols are attached to similar portions or to portions that perform similar functions, and duplicated explanation is omitted.

<Overall Explanation>

An information processing device may include a battery unit capable of supplying power as a backup power source for the information processing device, a power source unit (simply referred to as a power source sometimes) capable of charging the battery unit, and a charging control device for controlling charging of the battery unit. The information processing device may include a plurality of battery units. In many cases, the plurality of battery units is connected in parallel. For each battery unit, power that can be received is set as a specification and in the following, the power is referred to as maximum receivable power Pmb. Power that the power source unit connected to the battery unit can supply is referred to as maximum suppliable power Pmax. In the following, the maximum number of battery units that are connected to the charging control device is denoted by Xmax or simply by N. The N battery units adopt a redundant configuration. In the case where the voltage is fixed, the above-described power may also be replaced with a current. The maximum suppliable power Pmax is greater than the maximum receivable power Pmb. Power is supplied from the power source unit to the plurality of battery units connected in parallel.

In the above or following explanation, explanation is given by using the term “battery unit” sometimes, but in the present specification, the “battery unit” may also be referred to as a “battery” or a “cell” unless specified otherwise in particular. In general, the battery unit includes a plurality of batteries (cells). For each battery (cell), power that can be received is set as a specification and the maximum receivable power for the battery is also denoted by Pmb.

In the present specification, “to set a value” may mean to calculate a value, to select a value from a group of values determined in advance, to output information about a value of an element that performs an arithmetic operation in which the value is used, to store information about a value in a storage element such as a memory so that the value is read later, or a combination of the above.

Examples of the information processing device that is requested to have a high reliability as well as a high performance are a server, a computer system, a communication device, a storage device such as a memory device, etc.

In the embodiment of the information processing device and the charging method, the charged states of a plurality of battery units are acquired and processing to:

(a) select battery units to be charged; and

(b) determine charging power that will reduce the charging time,

is performed on the basis of the acquired charged states. It is preferable for the plurality of battery units to have the same characteristics. However, even in the case where all of the plurality of battery units do not have the same characteristics, the charging method that is described below may be applied after modifications that a person skilled in the art can easily think of.

By performing the processing as described above, in the embodiment of the information processing device and the charging method, it is possible to improve the charging efficiency by performing control so that the charging power that is supplied to the battery unit that needs charging is brought as close as possible to the maximum power that the power source can supply in the information processing device including a plurality of battery units. Further, in the embodiment of the information processing device and the charging method, for example, in the case where only a portion of the battery units need to be charged after a portion of the battery units are exchanged with new ones, it is possible to perform control so that the value of the charging current that is supplied to the battery unit that needs charging is brought as close as possible to the maximum current that the power source can supply.

In the embodiment of the information processing device and the charging method, in addition to the processing in (a) and (b) described above, it may also be possible to perform processing to (c) perform charging processing from the start in the case where any one of the battery units being charged is determined to be fully charged. By adding the processing such as this, the information processing device and the charging method that are disclosed below are configured so that only the battery units in the minimum necessary number are charged, and therefore, it is possible to reduce the time for charging. Further, it is possible to perform charging efficiently by making variable the charging characteristics, such as the charging power and the charging current, when charging the battery units as described above.

Here, the expression that the charging efficiency is high is used to mean that the time for charging is short.

<<Selection of Charging Candidate Battery Unit>>

First, a charging candidate battery unit, which is a candidate of a battery unit to be charged, is selected.

In the embodiment of the information processing device and the charging method, for the processing to select a charging candidate battery unit as a candidate of a battery unit to be charged in (a) described above, the rule that a fully charged battery unit is not charged is adopted.

In the case where all of the battery units are not fully charged, a charging candidate battery unit is selected from among the battery units that are not fully charged as follows.

First, a quantity of power Wbk that is used to operate a device to which the battery unit is connected when the external power source or the commercial power source fails temporarily, for example, at the time of power failure, is estimated. This power is called power for backup. The power for backup differs depending on the power consumption of the device to which the battery unit is connected and the power backup system in the position where the device is arranged. For example, the power for backup is the quantity of power that enables the storage device, such as a hard disk drive, to continue to operate for several hours and to hold the data stored in a volatile memory such as a cache memory even if the commercial power source stops temporarily in the storage system including the storage device. Conversely, the power for backup is determined in accordance with the device to which the battery unit is connected or the environment in which the device is placed. Consequently, if the power for backup Wbk is determined once, the value remains the same unless the environment in which the device is placed changes.

Next, a quantity of charge for backup Cbk that is the total sum of the quantities of charge of the battery units to supply the quantity of charge for backup Wbk by the battery units is estimated.

In the case where there are N (N is an integer equal to or greater than 2) battery units, the total quantity of charge that all of the N battery units preferably have in order to operate the device by the battery units alone is smaller than the total quantity of power when all of the N battery units are in the fully charged state and is expressed as an expression below.

Wbk≦Cmax×N (1)

Here, the quantity of charge for backup Cbk is defined as a maximum value of the power for backup Wbk. At this time, the quantity of charge for backup Cbk is expressed as an expression below.

Cbk≡Cmax×N (2)

Further, it may also be possible to define the quantity of charge for backup Cbk as the power for backup Wbk multiplied by a predetermined factor. In other words, it may also be possible to define the quantity of charge for backup Cbk by an expression below using Fbk as a factor that satisfies 0<Fbk<1.

Cbk=Fbk×Cmax×N (3)

In the storage device etc. that is requested to be highly reliable, there is a case where a redundant configuration is also adopted for the battery units for power source backup. In other words, the device is designed so that, in the case where N (N is an integer equal to or greater than 2) battery units are mounted in the device for power source backup, if the external power source or the commercial power source temporarily stops and the device is caused to operate by the battery units, the device is caused to operate by the (N−1) battery units. In this case, if all of the (N−1) battery units are in the fully charged state, in other words, if the quantity of charge of all of the (N−1) battery units is Cmax on the assumption that the maximum quantity of charge per battery unit is Cmax, the device will operate. Consequently, the power for backup Wbk for power source backup, i.e., the total quantity of charge that all of the N battery units preferably have in order to operate the device by the battery units alone is smaller than the total quantity of power in the case where all of the (N−1) battery units are in the fully charged state and is expressed as an expression below.

Wbk≦Cmax×(N−1) (4)

The lower limit of the power for backup Wbk depends on the device.

Here, the quantity of charge for backup Cbk is defined as a maximum value of the power for backup Wbk by an expression below.

Cbk=Cmax×(N−1) (5)

The quantity of charge or backup Cbk is the maximum quantity of charge Cmax per battery unit multiplied by (N−1), which is the minimum number of battery units to operate the device.

Of course, it may also be possible to define the quantity of charge for backup Cbk as the power for backup Wbk multiplied by a predetermined factor also in the case where the battery units adopt a redundant configuration. In other words, it may also be possible to define the quantity of charge for backup Cbk by an expression below using Fbk as a factor that satisfies 0<Fbk<1.

Cbk≡Fbk×Cmax×(N−1) (6)

Next, whether or not the total sum of the quantities of charge of all of the battery units exceeds the quantity of charge necessary for backup Cbk is determined. The determination results may have the following two cases.

(1) The case where the total sum of the quantities of charge of all of the battery units at that point in time exceeds the quantity of charge for backup Cbk

In this case, the battery unit that is not fully charged is selected as a charging candidate battery unit. In the following, it is assumed that the number of battery units that are not fully charged is Xcl.

(2) The case where the total sum of the quantities of charge of all of the battery units at that point in time does not exceed the quantity of charge for backup Cbk

In this case, first, a base quantity of charge Cb is defined as follows. Then, the battery unit whose quantity of charge does not reach the base quantity of charge Cb is selected as a charging candidate battery unit.

In the case where the Xmax battery units supply the power for backup Wbk, the quantity of power that the one battery unit preferably supplies is Wbk/Xmax. Because the quantity of charge for backup Cbk is defined as the maximum value of the power for backup Wbk, an expression below holds.

Wbk/Xmax≦Cbk/Xmax (7)

A value obtained by dividing the right side of the above expression by the maximum quantity of charge Cmax per battery unit is defined as a quantity of charge average QNCA by an expression below.

QNCA=Cbk/(Xmax×Cmax) (8)

It may also be possible to define the quantity of charge average QNCA as the quantity of base charge Cb by an expression below.

Cb≡QNCA (9)

It may also be possible to define the quantity of base charge Cb as the quantity of charge average QNCA multiplied by a predetermined factor. In other words, it may also be possible to define the base quantity of charge Cb by an expression below using Fb as a factor that satisfies 0<Fb<1.

Cb≡Fb×QNCA (10)

In the case where the total sum of the quantities of charge of all of the battery units does not exceed the quantity of charge for backup Cbk, whether or not the battery unit is charged is determined on the basis of whether or not the state of charge of the battery unit exceeds the base quantity of charge Cb. In other words, as a battery unit that is a candidate to be charged, the battery unit whose state of charge does not exceed the base quantity of charge Cb is selected as a charging candidate battery unit. It is assumed that the number of charging candidate battery units is Xbs.

<<Determination of Charging Characteristics>>

After a charging candidate battery unit is selected as a battery unit that is a candidate to be charged, a combination of a target battery unit, which is a battery unit that is charged so as to increase the charging efficiency, and charging power is determined.

(1) The case where the total sum of the quantities of charge of all of the battery units at that point in time exceeds the quantity of charge necessary for backup Cbk

In this case, the charging candidate battery units are the Xcl battery units that are not fully charged.

There are two cases, depending on whether or not the value obtained by dividing the maximum suppliable power Pmax, which is the power that the power source connected to the battery unit can supply, by Xcl exceeds the maximum receivable power Pmb that each battery unit can receive.

(1-1) The case where Pmax/Xcl exceeds the maximum receivable power Pmb

In this case, the value of the charging power is set so that the Xcl battery units that are not fully charged are charged by the maximum receivable power Pmb that each battery unit can receive.

(1-2) The case where Pmax/Xcl does not exceed the maximum receivable power Pmb

In this case, the value of the charging power is set so that the Xcl battery units that are not fully charged are charged by the value Pmax/Xcl obtained by dividing the maximum suppliable power Pmax, which is the power that the power source can supply, by the number Xcl of battery units that are not fully charged.

By setting the charging power as described above, it is possible to efficiently perform charging.

Further, in the case where the total sum of the quantities of charge of all of the battery units exceeds the quantity of charge for backup Cbk, it may also be possible to set a default value Pdef that is a value obtained by dividing the maximum power Pmax that the power source can supply by the maximum number Xmax of mounted battery units as the charging power.

Pdef=Pmax/Xmax (11)

(2) The case where the total sum of the quantities of charge of all of the battery units at that point in time does not exceed the quantity of charge for backup Cbk

In this case, in the embodiment of the information processing device and the charging method, two types are prepared as the method for determining charging characteristics: a pattern type and a variable type.

In the pattern type, several kinds of charging power (patterns) are set in advance and the one that brings the maximum charging efficiency is selected. In the variable type, a target battery unit is charged by the supplied power, which is determined on the basis of the maximum power that the power source can supply to the charging device.

(2-1) In the variable type, a set of a target battery unit, which is a battery unit that is actually charged, from among the charging candidate battery units, and charging power is determined on the following basis.

(α) The case where the product Pmb×Xbs of the maximum receivable power Pmb and the number Xbs of charging candidate battery units, which are the battery units whose state of charge does not exceed the base quantity of charge Cb, exceeds the maximum suppliable power Pmax, which is the power that that power source connected to the battery unit can supply

In this case, the value of the charging power is set so that the Xbs battery units whose state of charge does not exceed the base quantity of charge Cb are charged by the value Pmax/Xbs obtained by dividing the maximum suppliable power Pmax, which is the power that the power source can supply, by Xbs.

(β) The case where the product Pmb×Xbs of the maximum receivable power Pmb and the number Xbs of charging candidate battery units, which are the battery units whose state of charge does not exceed the base quantity of charge Cb, does not exceed the maximum suppliable power Pmax, which is the power that that power source connected to the battery unit can supply

In this case, the following two cases can be further considered.

(β-1) The case where the product Pmb×Xcl of the maximum receivable power Pmb and Xcl, which is the number of battery units that are not fully charged, does not exceed the maximum suppliable power Pmax

In this case, the value of the charging power is set so that the Xcl battery units that are not fully charged are charged by the maximum receivable power Pmb that each battery unit can receive.

(β-2) The case where the product Pmb×Xcl of the maximum receivable power Pmb and Xcl, which is the number of battery units that are not fully charged, exceeds the maximum suppliable power Pmax

In this case, the value of the charging power is set so that the Xcl battery units that are not fully charged are charged by the value Pmax/Xcl obtained by dividing the maximum suppliable power Pmax, which is the power that the power source can supply, by Xcl, which is the number of battery units that are not fully charged.

As described above, in the variable type, under the condition that the maximum receivable power Pmb that the battery unit can receive is not exceeded, the value of the charging power is set so that as many battery units as possible are charged by using the maximum power that the power source can supply as the charging power. By charging the battery units in this manner, it is possible to efficiently charge the battery units.

(2-2) Pattern Type

In the pattern type, several patterns of charging power are set in advance. For example, it is possible to set patterns 1 to 3 as follows:

(Pattern 1) Pmb,

(Pattern 2) 0.9×Pmb, and

(Pattern 3) 0.75×Pmb.

The charging power that is set as a pattern is not limited to those described above and the number of patterns is not also limited to three. However, the charging power does not exceed the maximum receivable power Pmb, which is the power that the battery unit can receive. For example, patterns may be

(Pattern 1) charging power corresponding to 2 C charging,

(Pattern 2) charging power corresponding to 1 C charging, and

(Pattern 3) charging power corresponding to 0.5 C charging. Here, “1 C charging” means to charge the battery unit with the same current as that of the discharge capacity of the battery unit by spending one hour. Consequently, the charging power corresponding to the 1 C charging is power corresponding to a charging current of 2 A in the case where the discharge capacity of the battery unit is 2 Ah.

The patterns of the charging power are not limited to the above, and it is possible to set an arbitrary value that does not exceed the maximum receivable power Pmb, which is the power that the battery unit can receive. By preparing several candidates for charging power in advance in this manner, it is possible to make simple the circuit to set the charging power.

Then, by comparing the following two cases, the case where the total quantity of power that is supplied from the power source (power source unit) for charging the battery unit is larger is adopted. Here, the “total quantity of power that is supplied from the power source for charging the battery unit” is the total quantity of power that is supplied to a plurality of battery units that are charged.

The two cases in the pattern type are the following cases.

(γ-1) The case where the Xbs battery units whose state of charge does not exceed the base quantity of charge Cb are charged by the charging power in the pattern that gives the maximum efficiency

(γ-2) The case where the Xcl battery units that are not fully charged are charged by the charging power in the pattern that gives the maximum efficiency

The situation as in the case of (γ-1) described above is brought about when a charging power Pbs that the power source supplies to each battery unit is the charging power in a maximum pattern Pattern1 that satisfies an expression below.

Pattern1≦Pmax/Xbs (12)

A total quantity of power Exbs in the case where the Xbs battery units are charged by the charging power Pbs is expressed by an expression below.

Exbs=Pattern1×Xbs (13)

Further, the situation as in the case of (γ-2) is brought about when the charging power Pbs that the power source supplies to each battery unit is the charging power in a maximum Pattern2 that satisfies an expression below.

Pattern2≦Pmax/Xcl (14)

A total quantity of power Excl in the case where the Xcl battery units are charged by the charging power Pbs is expressed as an expression below.

Excl=Pattern2×Xcl (15)

Then, by comparing the total quantity of power Exbs in the case where the Xbs battery units whose state of charge does not exceed the base quantity of charge Cb are charged by the charging power in the pattern Pattern1 and the total quantity of power Excl in the case where the Xc1 battery units that are not fully charged are charged by the charging power in the pattern Pattern2, the charging power whose value is greater is selected.

As described above, in the information processing device and the charging method of the embodiment, a plurality of battery units is provided and it is possible to improve the charging efficiency by performing control so that the charging power that is supplied to the battery unit that needs charging is brought as close as possible to the maximum power that the power source can supply.

It may also be possible to determine in advance whether the pattern type or the variable type is adopted. For example, it may also be possible to design the charging device so as to operate only in the pattern type or in the variable type. Alternatively, it may also be possible to design the charging device so as to be capable of switching between the pattern type and the variable type by using parts, such as a switching switch.

By using the charging device that performs the processing as described above in the information device such as the storage system, it is possible to obtain a high power-source backup performance.

In the above description, the value of the charging power is set, but it may also be possible to set the value of the charging current or another quantity in relation to the charging power such as a charge/discharge coefficient C.

<Configuration of Device>

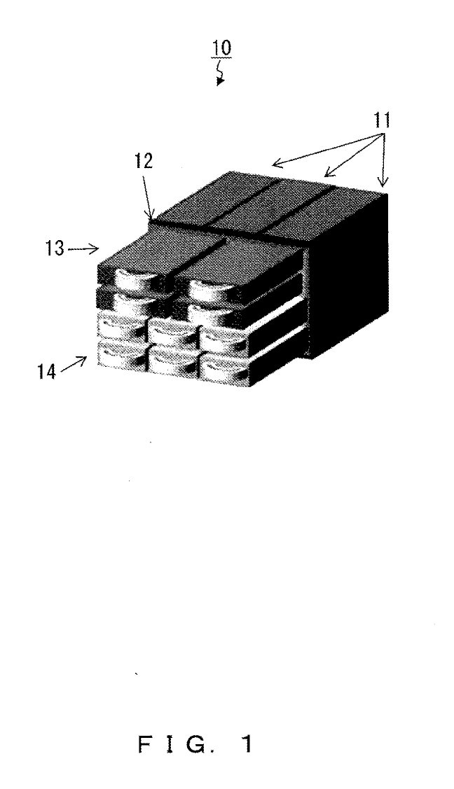

FIG. 1 is an example of an outline of a storage device 10 as one example of the information processing device.

In the following, the storage device is illustrated as one example of the information processing device. Another example of the information processing device includes an information processing device requested to be highly reliable, such as a server.

In the following also, “power” may be replaced with “current”, as in the above.

In the following explanation also, the term “battery unit” is used sometimes, but the “battery unit” may be replaced with a “battery” or “cell”.

The storage device 10, which is one example of the information processing device, includes a control unit 11, a backplane board 12, a battery unit 13, and a power source unit 14.

To the control unit 11, the backplane board 12 is connected, and to the backplane board 12, the battery unit 13 and the power source unit 14 are connected. The battery unit 13 may include a plurality of batteries.

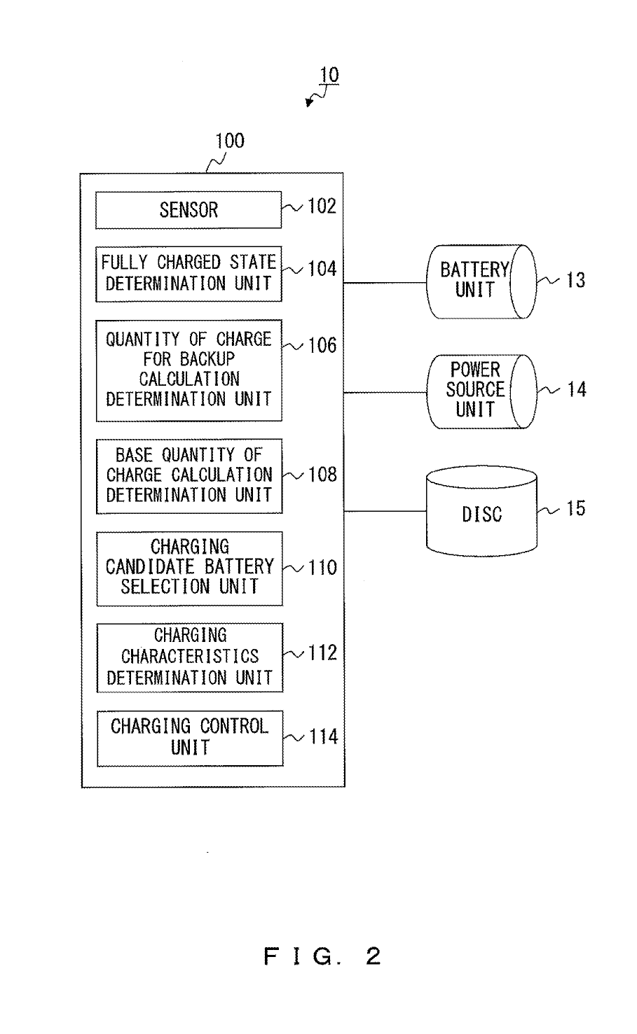

Further, the storage device 10 includes a disc (a disc 15 in FIG. 2). When the supply of power to the storage device 10 is cut off due to trouble etc. in the power source unit 14, the control unit 11 causes the battery unit 13 to operate so as to prevent the operation of the disc from being stopped part of the way in or to prevent data stored in a volatile memory such as a cache memory from being erased.

In the case of an information processing device other than the storage device, a unit that is different from the disc is connected to the portion of the disc in FIG. 2, and the information processing device is configured to perform a prescribed function as the information processing device.

Further, the control unit 11 monitors the charged situation of the battery unit 13 and has a function to charge the battery included in the battery unit 13 by using the output power of the power source unit 14 in accordance with necessity.

For each battery unit 13, power that can be received is set, and in the following, the power is referred to as the maximum receivable power Pmb. Further, the power that a plurality of power source units 14 can supply in total is referred to as the maximum suppliable power Pmax.

The backplane board 12 of the storage device 10 in FIG. 1 is configured so that the four battery units 13 and the six power source units 14 are connected. However, the number of battery units 13 and the number of power source units 14 included in the storage device 10 are not limited to those numbers. It is possible to connect the N battery units 13 and the M power source units 14 to the storage device 10.

A charging processing unit 100 monitors the charged state of the battery unit 13 and causes the power source unit 14 and/or the battery unit 13 to operate to charge the battery unit 13 in accordance with necessity.

The charging device may be configured by combining the charging processing unit 100 and the power source, such as the power source unit 14.

The power source unit 14 may be connected to the commercial power source.

FIG. 2 is an example of a function block diagram of the storage device 10.

The storage device 10 includes the charging processing unit 100, the battery unit 13, the power source unit 14, and the disc 15. The charging processing unit 100 may be configured by the control unit 11 and the backplane board 12 in FIG. 1.

The charging processing unit 100 includes a sensor 102, a fully charged state determination unit 104, a quantity of charge or backup calculation determination unit 106, abase quantity of charge calculation determination unit 108, a charging candidate battery selection unit 110, a charging characteristics determination unit 112, and a charging control unit 114.

The sensor 102 detects the connection state and the charged state of the battery unit 13 and the operation situation of the power source unit 14, and also functions as the charged state acquisition unit 102. The connection state of the battery unit includes the number of connected battery units that can operate.

The battery unit may mean (a plurality of) batteries included in the battery unit 13.

The charged state of the battery unit may include useful information for determining whether or not charging of the battery unit is performed, such as the charging rate of the battery unit and the temperature of the battery unit. Further, the operation situation of the power source unit 14 may include information to determine whether or not the power source unit 14 is operating normally, such as the output and temperature of the power source unit. Furthermore, the sensor 102 may also monitor the power etc. that is input to the disc 15. The input to an external device, which the sensor 102 monitors, may be a current or may be a voltage across both ends of the power source terminal of the disc 15.

The sensor 102 outputs the obtained information about the charged state of the battery unit and/or the operation situation of the power source unit 14 toward the fully charged state determination unit 104.

The sensor 102 functions as the charged state acquisition unit configured to obtain the quantity of charge of each of a plurality of battery units 13 and the total sum of the quantities of charge of the plurality of battery units.

The fully charged state determination unit 104 determines whether or not the battery unit 13 that is not in the fully charged state exists on the basis of the information obtained by the sensor 102, and in the case where a battery unit that is not fully charged exists, the fully charged state determination unit 104 determines the number Xcl of battery units that are not fully discharged. The fully charged state of the battery unit 13 may be a state where power in a prescribed ratio or higher of the capacity of the battery unit 13 is stored. The prescribed ratio is not limited to only 100% but may be a ratio less than 100%, such as 90% or 80%.

In the case where all of the battery units 13 connected to the charging processing unit 100 are in the fully charged state, it is not necessary to charge the battery unit 13. In this case, the processing to charge the battery unit 13 may be terminated.

In the case where a battery unit that is not fully charged exists, the fully charged state determination unit 104 regards the battery unit that is not fully charged as a charging candidate battery unit and outputs information about the charging candidate battery unit and the number Xcl of charging candidate battery units to the charging characteristics determination unit 120.

First, the quantity of charge for backup calculation determination unit 106 calculates the quantity of charge for backup Cbk, which is the total sum of the quantities of charge that all of the battery units preferably store when the power to operate the device that is connected to the charging processing unit 100, for example, the storage device 15, is supplied from the battery unit 13. The quantity of charge for backup Cbk may be defined by one of the above-described expression (2), expression (3), expression (5), and expression (6). In the present embodiment, the definition based on the expression (5) is used.

Further, the fully charged state determination unit 104 determines whether or not the total quantity of charge of the battery unit 13 exceeds the quantity of charge for backup Cbk. For example, in the case where the N battery units 13 are connected to the charging processing unit 100 and each quantity of charge of the N battery units 13 is assumed to be C1, C2, . . . , CN, the fully charged state determination unit 104 determines whether or not an expression below holds.

C1+C2+ . . . +CN<Cbk (16)

In the case where the total quantity of charge of the battery units 13 exceeds the quantity of charge for backup Cbk, the fully charged state determination unit 104 outputs information indicative of the total quantity of charge of the battery unit exceeding the quantity of charge for backup Cbk to the charging characteristics determination unit 112.

In the case where the total quantity of charge of the battery unit 13 does not exceed the quantity of charge for backup Cbk, the fully charged state determination unit 104 outputs information indicative of the total quantity of charge of the battery unit not exceeding the quantity of charge for backup Cbk to the quantity of base charge calculation determination unit 108.

The quantity of base charge calculation determination unit 108 calculates the base quantity of charge Cb, which is the quantity of charge that each battery unit 13 preferably stores when the quantity of charge for backup Cbk is supplied by the Xmax battery units 13. The base quantity of charge Cb is defined by, for example, the above-described expression (9).

Xmax is the number of battery units that are usually connected to the charging processing unit 100 and which supply power for the operation of the storage device 15 when the supply of power from the power source unit 14 is stopped. For example, when the battery units 13 have a redundant configuration and if trouble occurs in the power source unit 14, in the case where the (N−1) battery units of the N battery units operate, Xmax may be (N−1).

The charging candidate battery selection unit 110 determines the charging candidate battery unit, which is a battery unit that needs charging from among a plurality of battery units, and the number of charging candidate battery units on the basis of the quantity of charge of each of the plurality of battery units and the total sum of the quantities of charge of the plurality of battery units obtained by the sensor 102. For example, the charging candidate battery selection unit 110 selects a battery unit whose state of charge does not exceed the base quantity of charge Cb as a charging candidate battery unit, which is a candidate to be charged. Then, the charging candidate battery selection unit 110 sets the number of charging candidate battery units to Xbs.

The charging characteristics determination unit 112 determines a set of a target battery unit, which is a battery unit that is charged so that the charging efficiency is increased, and charging power. The target battery unit is selected from among the charging candidate battery units. It may also be possible for the charging characteristics determination unit 112 to determine a set of a target battery unit, which is a battery unit to be charged, and charging power so that the charging candidate battery unit is charged using the charging power that is either the value obtained by dividing the maximum suppliable power, which is the power that the power source unit 14 can supply, by the number of charging candidate battery units, or the maximum receivable power, which is the maximum power that the charging candidate battery unit can receives, whichever is smaller.

In the case where the total sum of the quantities of charge of all of the battery units 13 at that point in time exceeds the quantity of charge for backup Cbk, the charging candidate battery units are the Xcl battery units 13 that are not fully charged.

In order to determine the charging power that is supplied for charging the Xcl battery units 13, the charging characteristics determination unit 112 determines whether or not the value obtained by dividing the maximum suppliable power Pmax, which is the power that the power source connected to the battery unit 13 can supply, by Xcl exceeds the maximum receivable power Pmb that each battery unit can receive.

In the case where the value Pmax/Xcl obtained by dividing the maximum suppliable power Pmax that the power source connected to the battery unit 13 can supply by Xcl exceeds the maximum receivable power Pmb, the charging characteristics determination unit 112 sets the value of the charging power so that the Xcl battery units 13 that are not fully charged are charged by the maximum receivable power Pmb that each battery unit can receive.

As described previously, in the above description or in the following description, “to set a value” may mean to calculate a value, to select a value from among a group of values determined in advance, to output information about a value to an element that performs an arithmetic operation in which the value is used, to store information about a value in a storage element such as a memory so that the value is read later, or a combination of the above. For example, the value of the charging power may be stored in a memory included in the charging characteristics determination unit 112 so that the value is read by the charging control unit 114, to be described later. Further, the value of the charging power may be stored in a memory included in the charging control unit 114.

In the case where Pmax/Xcl does not exceed the maximum receivable power Pmb, the charging characteristics determination unit 112 sets the value of the charging power so that the Xcl battery units 13 that are not fully charged are charged by the value Pmax/Xcl obtained by dividing the maximum suppliable power Pmax, which is the power that the power source can supply, by the number Xcl of battery units 13 that are not fully charged.

Then, the charging characteristics determination unit 112 outputs the information about the set of the determined Xcl target battery units and the charging power Pmb or the Pmax/Xcl to the charging control unit 114.

In the case where the total sum of the quantities of charge of all of the battery units does not exceed the quantity of charge for backup Cbk, the charging characteristics determination unit 112 determines the charging characteristics in the above-described pattern type.

In the pattern type, several patterns of the charging power are set in advance. Then, the following two cases are compared and whichever is larger of the total quantities of power that are supplied from the power source to charge the battery unit 13 is adopted. These patterns may be stored in the memory included in the charging characteristics determination unit 112. Further, these patterns may be stored in the memory included in the charging control unit 114.

As the pattern, it is possible to set patterns 1 to 5 as follows.

(Pattern 1) Pmb

(Pattern 2) 0.9×Pmb

(Pattern 3) 0.7×Pmb

(Pattern 4) 0.5×Pmb

(Pattern 5) 0.3×Pmb

First, the total quantity of power Exbs in the case where the Xbs battery units 13 whose state of charge does not exceed the base quantity of charge Cb are charged by the charging power in the pattern that gives the maximum efficiency is calculated. At this time, the charging power Pbs that the power source supplies to each battery unit is the maximum pattern Pattern1 that satisfies the above-described expression (12) and the total quantity of power Exbs in the case where the Xbs battery units 13 are charged by the charging power Pbs is as expressed by the above-described expression (13).

Next, the total quantity of power Excl in the case where the Xcl battery units 13 that are not fully charged are charged by the charging power in the pattern that gives the maximum efficiency is calculated. At this time, the charging power Pbs that the power source supplies to each battery unit is the charging power in the maximum pattern Pattern2 that satisfies the above-described expression (14) and the total quantity of power Excl in the case where the Xcl battery units 13 are charged by the charging power Pbs is as expressed by the above-described expression (15).

Then, the charging characteristics determination unit 112 compares the total quantity of power Exbs in the case where the Xbs battery units whose state of charge does not exceed the base quantity of charge Cb are charged by the charging power in the pattern Pattern1 and the total quantity of power Excl in the case where the Xcl battery units that are not fully charged are charged by the charging power in the pattern Pattern2, and determines the battery unit having the larger value and the power in the pattern (Pattern1 or Pattern2) to be a set of the target battery unit and the charging power.

The charging control unit 114 charges the battery unit 13 on the basis of the set of the target battery unit and the charging power determined by the charging characteristics determination unit 112. In more detail, the charging control unit 114 reads the information about the set of the target battery unit and the charging power that is determined by the charging characteristics determination unit 112 and that is stored in the memory, supplies the charging power from the power source unit 14 to the predetermined battery unit 13, and charges the battery unit 13.

The charging control unit 114 resets the set of the target battery unit and the charging power in the case where there is a battery unit that newly enters the fully charged state after the charging is started.

### Modified Example

The charging characteristics determination unit 112 in the above-described embodiment determines the target battery unit and the charging power by the charging characteristics determination method in accordance with the pattern type.

However, the charging characteristics determination unit 112 may determine the target battery unit and the charging power by the charging characteristics determination method in accordance with the variable type.

In the variable type, a set of the target battery unit and the charging power is determined as follows.

In the case where the product Pmax×Xbs of the maximum suppliable power Pmax, which is the power that the power source connected to the battery unit 13 can supply, and the number Xbs of charging candidate battery units, which are battery units whose state of charge does not exceed the base quantity of charge Cb, exceeds the maximum suppliable power Pmax, the value of the charging power is set so that the Xbs battery units whose state of charge does not exceed the base quantity of charge Cb are charged by the value Pmax/Xbs obtained by dividing the maximum suppliable power Pmax, which is the power that the power source can supply, by Xbs.

In the case where the product Pmax×Xbs of the maximum suppliable power Pmax, which is the power that the power source connected to the battery unit can supply, and the number Xbs of charging candidate battery units does not exceed the maximum suppliable power Pmax, the following two cases can be considered further.

In the case where the product Pmax×Xcl of the maximum suppliable power Pmax and the number Xcl of battery units that are not fully charged does not exceed the maximum suppliable power Pmax, the value of the charging power is set so that the Xcl battery units that are not fully charged are charged by the maximum receivable power that each battery unit can receive.

In the case where the product Pmax×Xcl of the maximum suppliable power Pmax and the number Xcl of battery units that are not fully charged exceeds the maximum suppliable power Pmax, the value of the charging power is set so that the Xcl battery units that are not fully charged are charged by the value Pmax/Xcl obtained by dividing the maximum suppliable power, which is the power that the power source can supply, by the number Xcl of battery units that are not fully charged.

As described above, in the variable type, the value of the charging power is set so that the battery units as much as possible are charged by using the maximum power that the power source can supply as the charging power under the condition that the maximum power does not exceed the maximum receivable power Pmb, which is the power that the battery unit can receive. By charging the battery unit in this manner, it is possible to efficiently charge the battery unit.

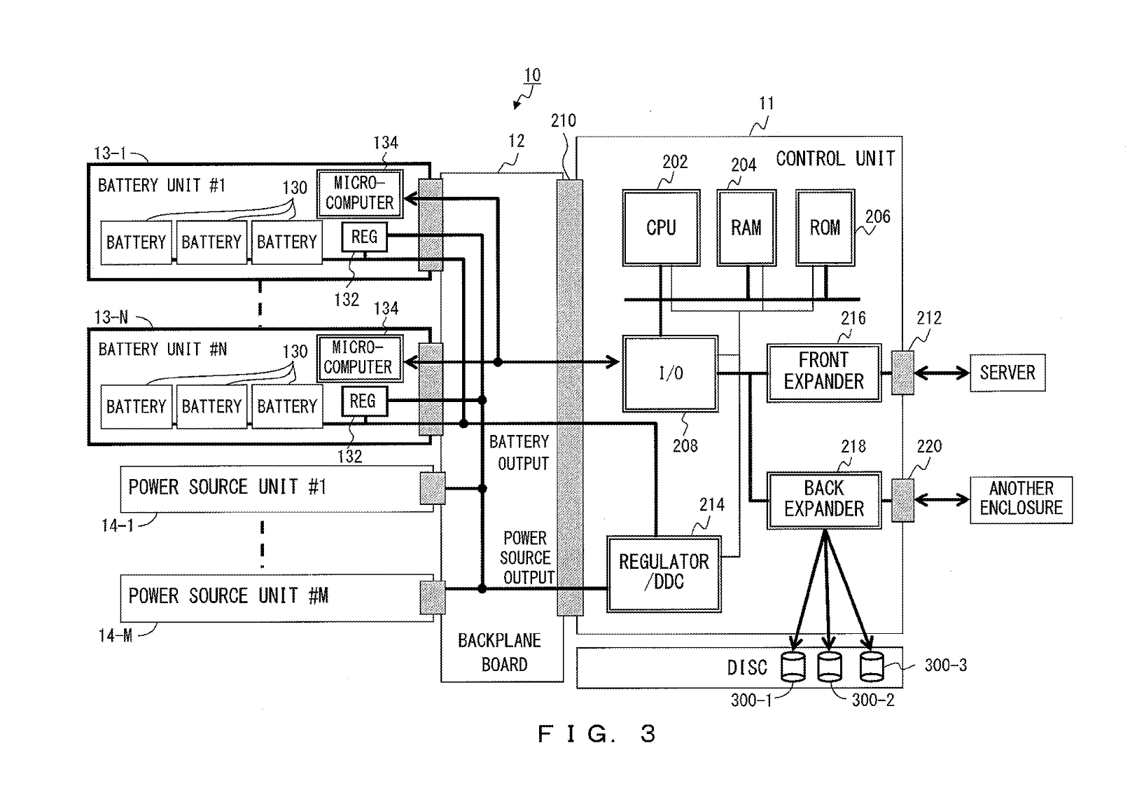

FIG. 3 is an example of a device configuration diagram of the storage device 10.

The storage device 10 includes the control unit 11, the backplane board 12, battery units 13-1, . . . , 13-N, and power source units 14-1, . . . , 14-M. The control unit 11 is configured as a board-shaped module. The control unit 11 includes a central processing unit (CPU) 202, a random access memory (RAM) 204, a read-only memory (ROM) 206, an I/O (I/O controller) 208, a connector 210, terminals 212, 220, a regulator/DDC 214, a front expander 216, a back expander 218, and discs 300-1, 300-2 and 300-3. In FIG. 3, the three discs 300-1, 300-2 and 300-3 are illustrated, but the storage device 10 may include an arbitrary number of discs.

The terminal 212 of the control unit 11 is a terminal for a cable that is connected to transmit and receive an electric signal in order to transfer information between an external device, for example, such as a server and a storage system, and the storage device 10. As will be described later, a configuration may be designed such that power of the battery units 13-1, . . . , 13-N or the power source units 14-1, . . . 14-M is output from the terminal 212. Although not illustrated, there may be separately provided a terminal from which the power of the battery units 13-1, . . . , 13-N or the power source units 14-1, . . . , 14-N is output.

A signal from an external device, which is input to the terminal 212 of the control unit 11, is sent to the CPU 202 via a bus through the I/O 208 and is subjected to processing therein. The CPU 202 is an operation processing device that controls the operation of the whole of the control unit 11 and functions as a control processing unit of the storage device 10.

The I/O 208 manages transmission and reception of various kinds of information with various kinds of equipment connected to the control unit 11 via the front expander 216 or the back expander 218. In particular, the I/O device 208 manages transmission and reception of information with the server, which is connected to the terminal 212, via the front expander 216. Further, the I/O 208 manages transmission and reception of information with an enclosure other than the storage device 10, which is connected to the terminal 220, or with the discs 300-1, 300-2 and 300-3 of the storage device 10 via the back expander 218. The front expander 216 and the back expander 218 are used to extend the function of the I/O 208.

To the CPU 202 (processor), the RAM 204 and the ROM 206 are connected via a bus.

The RAM 204 is a memory to and from which data can be written and read at any time and which is used as a work storage area in accordance with necessity when the CPU 202 executes various control programs.

In the ROM 206, prescribed basic control program may be stored in advance. By the CPU 202 reading the basic control program from the ROM 206 and executing the program when the storage device 10 is activated, it is made possible to control the operation of each component of the storage device 10.

The regulator/DDC 214 of the control unit 11 is connected to the terminal of the backplane board 12 that is connected to the battery units 13-1, . . . , 13-N and to the terminal of the backplane board 12 that is connected to the power source units 14-1, . . . , 14-M. The regulator/DDC 214 has the function of a DC-DC converter and the function of a regulator and, for example, converts an input voltage into a prescribed fixed output voltage and outputs power to each unit of the control unit 11 and to external devices.

In order to configure each unit of the storage device 10 by using the control unit 11 such as this, for example, a control program for causing the CPU 202 to perform the various kinds of control processing as described above are created. It may also be possible to store the created control program in the ROM 206 or in an external device and to load the program onto the RAM 204 at the same time as the control unit 11 is activated. Then, predetermined instructions are given to the CPU 202 so as to cause the CPU 202 to read and execute the control program. By doing so, the functions comprised by each unit of the storage device 10 illustrated in FIG. 2, i.e., the fully charged state determination unit 104, the quantity of charge for backup calculation determination unit 106, the base quantity of charge calculation determination unit 108, the charging candidate battery selection unit 110, the charging characteristics determination unit 112, and the charging control unit 114, are provided by the CPU 202. In the RAM 204 or the ROM 206, the charging patterns in the case where charging is performed in the pattern type, the values of the charging power calculated by the CPU 202, etc., are stored and are read when charging is controlled.

Each of the power source units 14-1, . . . , 14-M is connected to an alternating-current power source, such as the commercial power source, and converts alternating-current power supplied from the alternating-current power source into direct-current power and supplies the direct-current power to the regulator/DDC 214 of the control unit 11 and/or the battery units 13-1, . . . , 13-N.

The configuration of the battery units 13-1, . . . 13-N will be explained later in detail. Each of the battery units 13-1, . . . , 13-N includes a plurality of batteries 130-1, 130-2 and 130-3, a regulator 132, and a computer (microcomputer) 134. As will be described later, the microcomputer 134 has the function of a sensor that detects an electric current that is input to the battery 130 or output from the battery. In the present embodiment, one battery unit includes three batteries, but one battery unit may include four or more batteries or two or fewer batteries.

The microcomputer 134 of the battery units 13-1, . . . 13-N is connected to the I/O 208 of the control unit 11 via the backplane board 12 and the connector 210. Between the battery units 13-1, . . . , 13-N and the control unit 11, information is transferred, such as the charged state of the batteries 130-1, 130-2 and 130-3 of the battery units 13-1, . . . , 13-N, the value of the electric current and/or voltage that is input to the battery 130 or output from the battery 130, and whether the battery 130 is in the charged state or in the discharged state. The charged state of the battery 130 may be the charging rate.

The regulator 132 of the battery units 13-1, 13-N is connected to the output terminal of the power source units 14-1, . . . , 14-M. Further, the regulator 132 is connected to the microcomputer 134, although not illustrated, and the microcomputer 134 of the battery units 13-1, . . . , 13-N controls the regulator 132, switches between the charged state and the discharged state of the batteries 130-1, 130-2 and 130-3, and adjusts the charging power (charging current) in the charged state upon receipt of a command from the control unit 11.

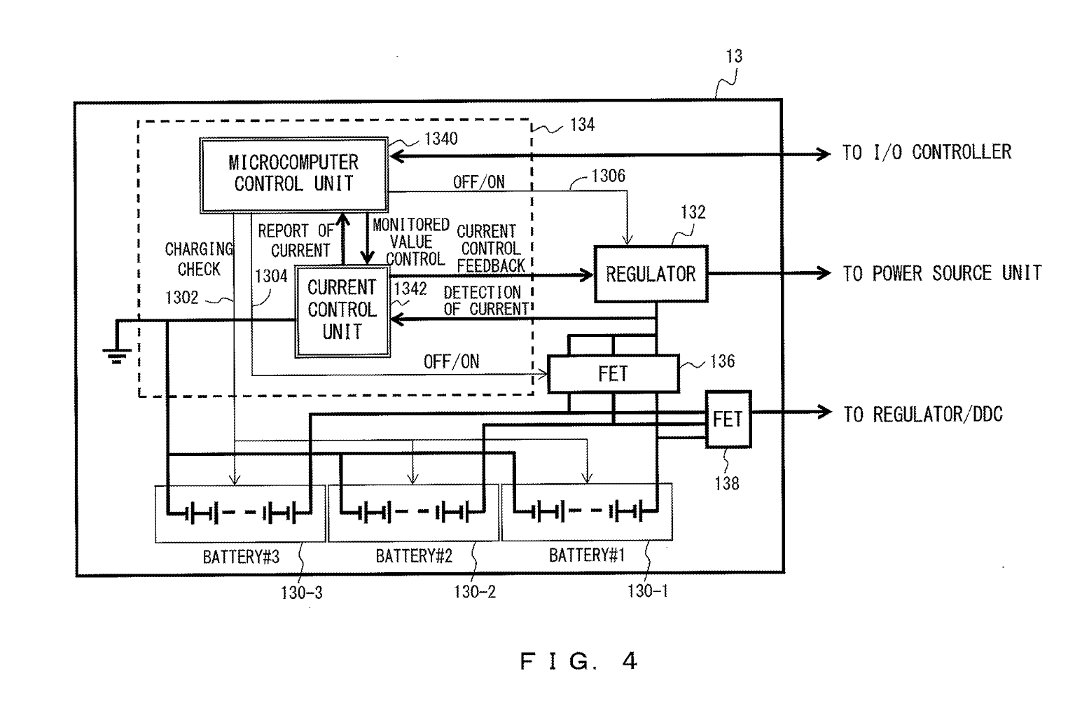

FIG. 4 is an example of a device configuration diagram of the battery unit 13.

The battery unit 13 includes the batteries 130-1, 130-2 and 130-3, the regulator 132, the microcomputer 134, and FETs 136 and 138. The microcomputer 134 further includes a microcomputer control unit 1340 and a current control unit 1342.

The microcomputer control unit 1340 is connected to the I/O 208 of the control unit 11. The microcomputer control unit 1340 is connected to the regulator 132 via a control line 1306. The current control unit 1342 is connected with the microcomputer control unit 1340. The current control unit 1342 monitors the electric current that flows through each of the batteries 130-1, 130-2 and 130-3 and, at the same time, controls the regulator 132 on the basis of the command received from the microcomputer control unit 1340 and adjusts the electric current (charging current) that flows through the batteries 130-1, 130-2 and 130-3. The FET 136 is arranged between the regulator 132 and the batteries 130-1, 130-2 and 130-3 and controls an ON or OFF of each of the batteries 130-1, 130-2 and 130-3 on the basis of the command from the microcomputer control unit 1340. The FET 138 is arranged between the batteries 130-1, 130-2 and 130-3 and the regulator/DDC 214 of the control unit 11 and controls the output of the batteries 130-1, 130-2 and 130-3 on the basis of the command from the microcomputer control unit 1340.

The regulator 132, the microcomputer 134, and the FETs 136 and 138 of the battery unit 13 are combined with the control unit 11 and implement the functions comprised by the sensor 102 and the charging control unit 114 of the storage device 10 illustrated in FIG. 2.

<Charging Method>

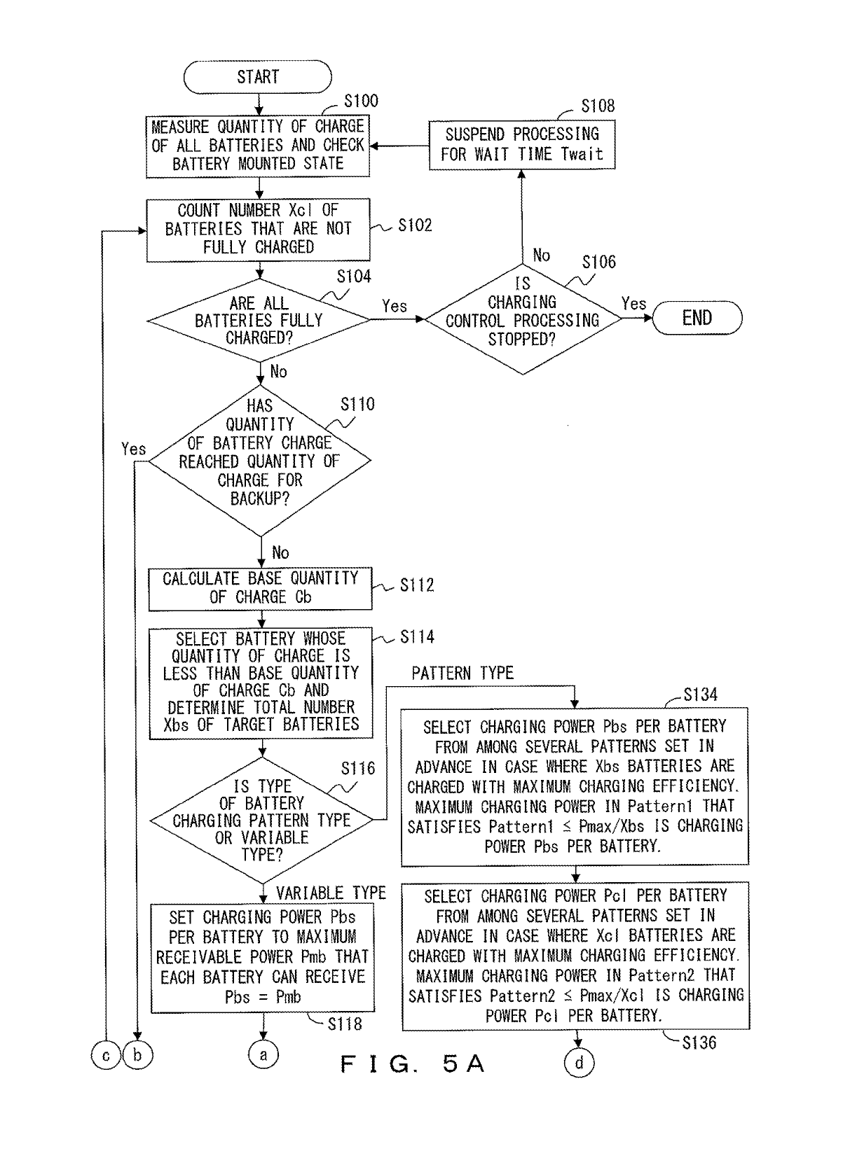

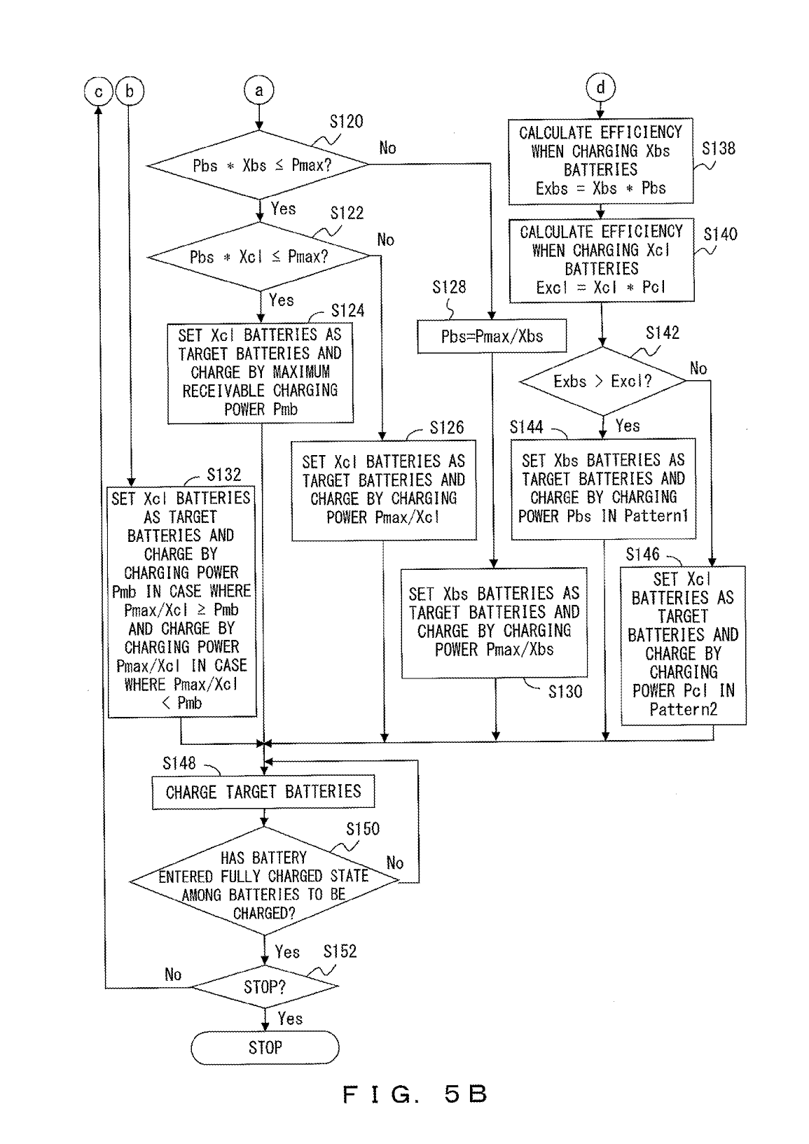

With reference to FIG. 5A and FIG. 5B, the flow of the processing in an example of the charging method is explained. FIG. 5A and FIG. 5B are a flowchart illustrating processing of an embodiment of the charging method.

In the following, there is a case where explanation is given by using the term “battery unit”, but the “battery unit” may be replaced with the “battery” as in FIG. 5A and FIG. 5B. A battery unit may include a plurality of batteries. For each battery, the power that each battery can receive is set as the specifications and the maximum receivable power for the battery is also denoted as Pmb.

When the processing starts, first, at step S100, the quantity of charge of all of the battery units is measured. Further, at the same time, the battery mounted state is checked. The battery mounted state may be the number of batteries or battery units that are mounted. The quantity of charge of all of the battery units may be, for example, in the situation illustrated in FIG. 3, the quantity of charge of each of the battery units 13-1, . . . , 13-N and the total sum of the quantities of charge of the battery units 13-1, . . . , 13-N, or may be the quantity of charge of each of the batteries 130-1, 130-2 and 130-3 included in the battery units 13-1, . . . , 13-N and the total sum of the quantities of charge thereof.

In the following, it is assumed that the N battery units 13 exist and that the quantity of charge of each of the N battery units 13 is C1, C2, . . . , CN.

At step S102 subsequent to step S100, the number Xcl of battery units that are not fully charged is counted. This processing may be performed by using the sensor 102 in FIG. 2.

At step S104 subsequent to step S102, whether or not all of the battery units are fully charged is determined. This processing may be performed by determining whether or not all of the battery units are fully charged on the basis of the number Xcl of battery units that are not fully charged, which has been counted at step S102. Alternatively, it may also be possible to determine whether or not all of the battery units are fully charged by taking into consideration the quantity of charge of all of the battery units obtained at step S100.

In the case where the result of the determination at step S104 is Yes, i.e., in the case where all of the battery units are fully charged, the processing proceeds to step S106.

At step S106, whether or not the charging control processing is aborted (stopped) is determined. For example, in the case where a command to abort the processing has been input from the outside, it may also be possible to determine that the processing is aborted. Alternatively, the determination may be performed by using another criterion. In the case where the result of the determination at step S106 is Yes, i.e., in the case where it is determined that the charging control processing is aborted, the charging control processing is terminated. In the case where the result of the determination at step S106 is No, i.e., in the case where it is determined that the charging control processing is not aborted, the processing proceeds to step S108.

At step S108, the processing is aborted for a wait time Twait, which is a time determined in advance. Then, the processing returns to step S100.

In the case where the result of the determination at step S104 is No, i.e., in the case where all of the battery units are not fully charged, the processing proceeds to step S110.

The processing at steps S102 to S108 may be performed by using the fully charged state determination unit 104 in FIG. 2.

At step S110, whether or not the quantity of battery charge has reached the quantity of charge for backup Cbk is determined. The quantity of charge for backup Cbk may be defined by one of the above-described expression (2), expression (3), expression (5), and expression (6). In the present embodiment, the quantity of charge for backup Cbk is defined by the above-described expression (5), and therefore, in this step, whether or not an expression (17) below holds is determined.

C1+C2+, . . . ,+CN<Cbk=Cmax×(N−1) (17)

The quantity of charge for backup Cbk may be defined by another expression different from the above-described expression (17).

In the case where the result of the determination at step S110 is Yes, i.e., in the case where the quantity of battery charge has reached the quantity of charge for backup, the processing proceeds to step S132.

The processing at step S110 may be performed by using the quantity of charge for backup calculation determination unit 106 in FIG. 2.

At step S132, the target battery unit to be charged and the charging power are set as follows.

In this case, it is assumed that the charging candidate battery units are the Xcl battery units that are not fully charged. This setting may be done by using the charging candidate battery selection unit 110 in FIG. 2. In this case, depending on whether or not the value obtained by dividing the maximum suppliable power Pmax, which is the power that the power source connected to the battery unit can supply, by Xcl exceeds the maximum receivable power Pmb that each battery unit can receive, there are two cases as follows.

In the case where Pmax/Xcl exceeds the maximum receivable power Pmb, the value of the charging power is set so that the Xcl battery units that are not fully charged are charged by the maximum receivable power Pmb that each battery unit can receive. Then, the processing proceeds to step S148.

In the case where Pmax/Xcl does not exceed the maximum receivable power Pmb, the value of the charging power is set so that the Xcl battery units that are not fully charged are charged by the value Pmax/Xcl obtained by dividing the maximum suppliable power Pma, which is the power that the power source can supply, by the number Xcl of battery units that are not fully charged. Then, the processing proceeds to step S148.

This setting may be done by using the charging characteristics determination unit 112 in FIG. 2.

As in the above, “setting a value” may include calculating a value, selecting a value, and storing a value in a storage element such as a memory so that the value is read later. For example, the value of the charging power may be stored in a memory included in the charging characteristics determination unit 112 so that the value is read by the charging control unit 114, to be described later. Further, the memory may be included in the charging control unit 114.

In the case where the result of the determination at step S110 is No, i.e., in the case where the quantity of battery charge has not reached the quantity of charge for backup, the processing proceeds to step S112.

At step S112, the base quantity of charge Cb is calculated. This processing may be performed by using the base quantity of charge calculation determination unit 108 in FIG. 2.

It is assumed that the base quantity of charge Cb is defined by an expression below on a condition that Xmax=N in the above-described expression (9).

Cb≡Cbk/(N×Cmax) (18)

The base quantity of charge Cb may be defined by another expression different from the above expression (18).

At step S114 subsequent to step S112, the battery units whose state of charge does not exceed the base quantity of charge Cb are selected and the number of such battery units is taken to be Xbx. Then, those battery units are regarded as charging candidate battery units. This processing may be performed by using the charging candidate battery selection unit 110 in FIG. 2. Then, the processing proceeds to step S116.

At step S116, whether the charging type is the pattern type or the variable type is determined.

The charging type may be set to the pattern type or the variable type as hardware, or may be specified by software. In the case of the variable type, the processing proceeds to step S118. In the case of the pattern type, the processing proceeds to step S134.

(Variable Type)

In the case where the charging type is determined to be the variable type by the determination at step S116, first, at step S118, the charging power Pbs per battery is set to the maximum receivable power Pmb that each battery unit can receive.

At step S120 subsequent to the step S118, whether or not the product Pmb×Xbs of the maximum receivable power Pmb and the number Xbs of charging candidate battery units, which are the battery units whose charging rate does not exceed the base quantity of charge Cb, does not exceed the maximum suppliable power Pmax, which is the power that the power source connected to the battery unit can supply, is determined.

In the case where the result of the determination at step S120 is Yes, i.e., in the case where the product Pmb×Xbs of the maximum receivable power Pmb and the number Xbs of charging candidate battery units does not exceed the maximum suppliable power Pmax, the processing proceeds to step S122. In the case where the result of the determination at step S120 is No, i.e., in the case where the product Pmb×Xbs of the maximum receivable power Pmb and the number Xbs of charging candidate battery units exceeds the maximum suppliable power Pmax, the processing proceeds to step S128.

At step S128, the value Pmax/Xbs obtained by dividing the maximum suppliable power Pmax that the power source can supply by Xbs is calculated and is set as Pbs.

At step S130 subsequent to step S128, the Xbs battery units whose charging rate does not exceed the base quantity of charge Cb are set as the target battery units to be charged and the setting is performed so that the target battery units are charged by the charging power Pbs=Pmax/Xbs. Then, the processing proceeds to step S148.

In the case where the result of the determination at step S120 is Yes, i.e., in the case where the product Pmb×Xbs of the maximum receivable power Pmb and the number Xbs of charging candidate battery units does not exceed the maximum suppliable power Pmax, at step S122, whether or not the product Pmb×Xbs of the maximum receivable power Pmb and the number Xbs of charging candidate battery units, which are the battery units whose charging rate does not exceed the base quantity of charge Cb, is equal to or less than the maximum suppliable power Pmax, which is the power that the power source connected to the battery unit can supply, is determined.

In the case where the result of the determination at step S122 is Yes, i.e., in the case where the product Pmb×Xbs of the maximum receivable power Pmb and the number Xbs of charging candidate battery units is equal to or less than the maximum suppliable power Pmax, which is the power that the power source connected to the battery unit can supply, the processing proceeds to step S124. In the case where the result of the determination at step S122 is No, i.e., in the case where the product Pmb×Xbs of the maximum receivable power Pmb and the number Xbs of charging candidate battery units exceeds the maximum suppliable power Pmax, which is the power that the power source connected to the battery unit can supply, the processing proceeds to step S126.

At step S124, the setting is performed so that the Xcl battery units that are not fully charged are charged by the maximum receivable power Pmb that each battery unit can receive. Then, the processing proceeds to step S148.

At step S126, the setting is performed so that the Xcl battery units that are not fully charged are charged by the value Pmax/Xcl obtained by dividing the maximum suppliable power Pmax, which is the power that the power source can supply, by the number Xcl of battery units that are not fully charged. Then, the processing proceeds to step S148.

At step S148, the target battery units are charged by the set charging power. In the case where the information about the target battery units and the charging power is stored in the memory included in the charging characteristics determination unit 112, etc., at this step, the information about the target battery units and the charging power is read from the memory and the target battery units are charged by the charging control unit 114 using the set charging power.

In this processing, the target battery units are charged for a prescribed period of time. As the prescribed period of time, an arbitrary time, such as 30 seconds, one minute, five minutes, ten minutes, and thirty minutes, can be set.

At step S150 subsequent to step S148, whether or not there has occurred a battery unit that is fully charged among the battery units to be charged is determined.

In the case where the result of the determination at step S150 is No, i.e., there has not occurred a battery unit that is fully charged among the battery units to be charged, the processing returns to step S148 and charging is continued.

In the case where the result of the determination at step S150 is Yes, i.e., where there has occurred a battery unit that is fully charged among the battery units to be charged, the processing proceeds to step S152.

At step S152, the same processing as that at step S106 is performed.

In the case where the result of the determination at step S152 is No, i.e., in the case where it is determined that the charging control processing is not aborted, the processing proceeds to step S102. In the case where the result of the determination at step S152 is Yes, i.e., in the case where it is determined that the charging control processing is aborted, the charging control processing is terminated.

The processing at steps S148 to S152 may be performed by using the charging control unit 114 in FIG. 2.

(Pattern Type)

In the case where the charging pattern is determined to be the pattern type by the determination at step S116, first, at step S134, a pattern that is used when charging the Xbs battery units whose state of charge does not exceed the base quantity of charge Cb by the charging power in the pattern that gives the maximum efficiency is selected. The pattern Pattern1 at this time is the maximum pattern that satisfies an expression below.

Pattern1≦Pmax/Xbs (19)

The charging power in Pattern1 is set to Pbs.

At step S138, the total quantity of power Exbs in the case where the Xbs battery units are charged by the charging power Pbs selected at step S134 is calculated. The total quantity of power Exbs is defined by an expression below.

Exbs=Pattern1×Xbs (20)

At step S136 subsequent to step S134, a pattern in the case where the Xcl battery units that are not fully charged are charged by the charging power in the pattern that gives the maximum efficiency is selected.

The pattern Pattern2 at this time is the maximum pattern that satisfies an expression below.

Pattern2≦Pmax/Xcl (21)

The charging power in Pattern2 is set to Pcl.

At the next step S140, the total quantity of power Excl in the case where the Xcl battery units are charged by the charging power Pcl selected at step S136 is calculated. The total quantity of power Excl is defined by an expression below.

Excl=Pattern2×Xcl (22)

The order of the processing at step S134 and that at step S136 may be reversed and the order of the processing at step S138 and that at step S140 may be reversed.

Next, at step S142, whether or not an expression below holds is determined.

Pattern1×Xbs=Exbs>Excl=Pattern2×Xcl (23)

In the case where the result of the determination at step S142 is Yes, i.e., in the case where the total quantity of power Exbs in the case where the Xbs battery units whose state of charge does not exceed the base quantity of charge Cb are charged by the charging power in the pattern Pattern1 is greater than the total quantity of power Excl in the case where the Xcl battery units that are not fully charged are charged by the charging power in the pattern Pattern2, the processing proceeds to step S144.

Further, in the case where the result of the determination at step S142 is No, i.e., in the case where the total quantity of power Exbs in the case where the Xbs battery units whose state of charge does not exceed the base quantity of charge Cb are charged by the charging power in the pattern Pattern1 is equal to or less than the total quantity of power Excl in the case where the Xcl battery units that are not fully charged are charged by the charging power in the pattern Pattern2, the processing proceeds to step S146.

At step S144, the setting is performed so that the Xbs battery units whose state of charge does not exceed the base quantity of charge Cb are charged by the charging power Pbs in the pattern Pattern1. Then, the processing proceeds to step S148.

At step S146, the setting is performed so that the Xcl battery units that are not fully charged are charged by the charging power in the pattern Pattern2. Then, the processing proceeds to step S148.

The processing at steps S116 to 146 may be performed by using the charging characteristics determination unit 112 in FIG. 2.

The processing at step S148 and subsequent steps is the processing that has already been explained.

As described above, in the information processing device and the charging method of the embodiment, a plurality of battery units is comprised and it is possible to improve the charging efficiency by performing control so as to bring the charging power that is supplied to the battery unit that needs charging as close as possible to the maximum power that the power source can supply.

Further, by using the charging device that performs the processing as described above in the information device such as the storage system, it is possible to obtain a high power-source backup performance.

### First Embodiment

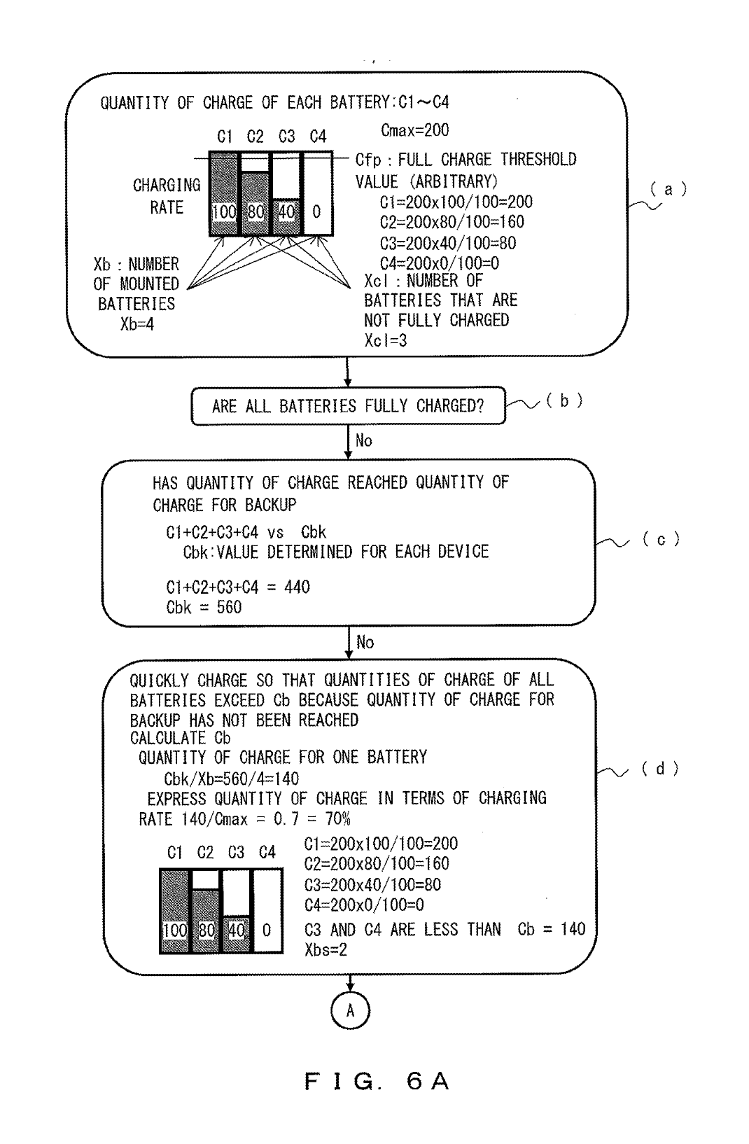

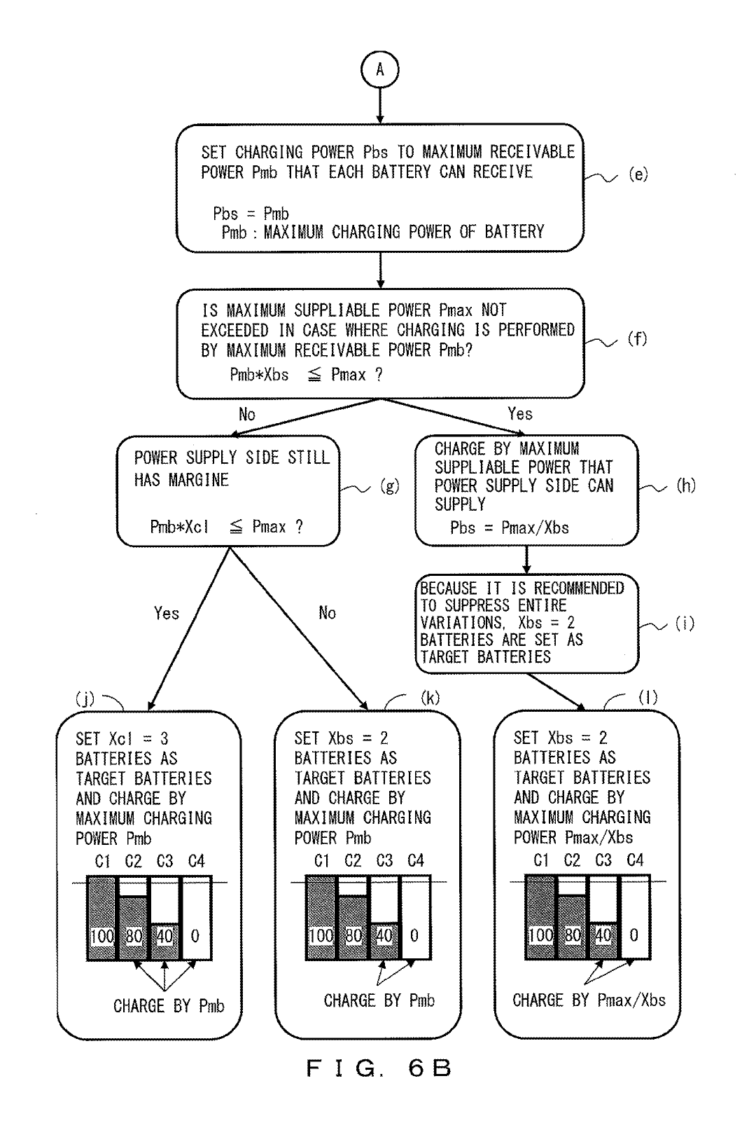

A first embodiment is explained with reference to FIGS. 6A and 6B.

In the present embodiment, the charging characteristics, i.e., the target battery and the charging power, are set as the variable type. In the following, it is assumed that one of the charging characteristics is specified by the value of the power that is supplied to the battery from the power source, but may be specified by the value of an electric current.

As in (a) in FIG. 6A, it is assumed that there are four batteries 1 to 4. In other words, if the number of mounted batteries is denoted by Xb (sometimes written as Xmax as described above), Xb=4.

The present embodiment is an example of the charging method in the case where the sum of the quantities of charge of the four batteries does not reach the quantity of charge for backup. In the present embodiment, explanation is given by using the term “battery”, but “battery” may be replaced with “battery unit”.

The quantity of charge or charging rate of each of the four batteries is measured as in the processing at step S100 in FIG. 5A. It is assumed that the results of the measurement are C1=100%, C2=80%, C3=40%, and C4=0%, where C1, C2, C3, and C4 are the charging rates of the four batteries 1 to 4, respectively.

It is assumed that the quantity of charge Cmax of each battery in the fully charged state is 200 mAh. Of course, it may also be possible to use batteries having another rating.

At this time, the quantities of charge of the four batteries are as follows.

Battery 1: C1=200 [mAh]×100/100 [%]=200 [mAh]

Battery 2: C2=200 [mAh]×80/100 [%]=160 [mAh]

Battery 3: C3=200 [mAh]×40/100 [%]=80 [mAh]

Battery 4: C4=200 [mAh]×0/100 [%}=0 [mAh]

In (b) in FIG. 6A, whether all of the batteries are fully charged is determined as in the processing at step S104 in FIG. 5A. In the case where all of the batteries are fully charged, the charging control processing is terminated. If a full-charge threshold value Cfp is assumed to be 92%, only the battery 1 reaches the full-charge level and the number of batteries whose charging rate does not exceed the full-charge threshold value Cfp is three, and therefore, the number Xcl of batteries that are not fully charged is three, i.e., Xcl=3.

Next, in (c) in FIG. 6A, whether the sum of the quantities of charge of the four batteries reaches the quantity of charge for backup Cbk is determined as in the processing at step S110 in FIG. 5A. Here, if the quantity of charge for backup Cbk is assumed to be 560, C1+C2+C3+C4=440, and therefore, the sum of the quantities of charge of the four batteries does not reach the quantity of charge for backup Cbk, and therefore, it will be determined that C1+C2+C3+C4<Cbk.

Next, in (d) in FIG. 6A, first, the base quantity of charge Cb is calculated as in the processing at step S112 in FIG. 5A.

The base quantity of charge Cb is the quantity of charge that each battery preferably stores in the case where the quantity of charge or backup Cbk is supplied by the number Xb=4 of mounted batteries, and the base quantity of charge Cb is calculated by an expression below.

Cbk/Xb=560/4=140 [mAh]

If this is expressed in terms of the charging rate, 140/Cmax=0.7=70% is obtained.

Next, as in the processing at step S114 in FIG. 5A, the battery whose charging rate does not exceed 70%, which is the quantity of charge for backup Cbk, is selected and the number Xbs of such batteries is obtained. The battery whose charging rate does not exceed 70%, which is the quantity of charge for backup Cbk, is the battery 3 and the battery 4. Therefore, the number Xbs of batteries whose charging rate does not exceed the base quantity of charge Cb is two, i.e., Xbs=2.

In (e) in FIG. 6B, as in the processing at step S118 in FIG. 5A, the charging power Pbs per battery is set to the maximum receivable power Pmb that each battery can receive.

In (f) in FIG. 6B, as in the processing at step S120 in FIG. 5B, whether the maximum suppliable power Pmax is not exceeded in the case where charging is performed at the maximum receivable power Pmb is determined.

In the case where the result of the determination in (f) in FIG. 6B is Yes, i.e., in the case where the maximum suppliable power Pmax is not exceeded even in the case where charging is performed at the maximum receivable power Pmb, the power supplying side still has a margin as in (g) in FIG. 6B. Consequently, whether it is possible to charge the Xcl batteries that are not fully charged by the maximum receivable power Pmb of the battery is determined. In the case where the result of the determination in (g) in FIG. 6B is Yes, i.e., in the case where Pbs×Xcl Pmax, the Xcl=3 batteries, i.e., the batteries 2 to 4 are set as the target batteries to be charged and the setting is performed so that charging is performed at the maximum receivable power Pmb of the battery.

In the case where the result of the determination in (g) in FIG. 6B is No, i.e., in the case where Pbs×Xcl≧Pmax, as in (k) in FIG. 6B, the Xbs=2 batteries, i.e., the batteries 3 and 4 are set as the target batteries to be charged and the setting is performed so that charging is performed at the maximum receivable power Pmb of the battery.

In the case where the results of the determination in (f) in FIG. 6B are No, i.e., in the case where the maximum suppliable power Pmax is exceeded if charging is performed at the maximum receivable power Pmb, the setting is performed so that charging is performed at the maximum power that the supply side can supply, as in (h) in FIG. 6B. In other words, the charging power Pbs is set to Pmax/Xbs.

Here, as in (i) in FIG. 6B, it is important to suppress the variations between the four batteries, and therefore, the target batteries are the two batteries: the batteries 3 and 4.

Ultimately, as in (1) in FIG. 6B, the setting is performed so that the Xbs=2 batteries are charged by the charging power Pmax/Xbs.

After the batteries to be charged and the charging power are set, the target batteries are charged by the set charging power.

### Second Embodiment

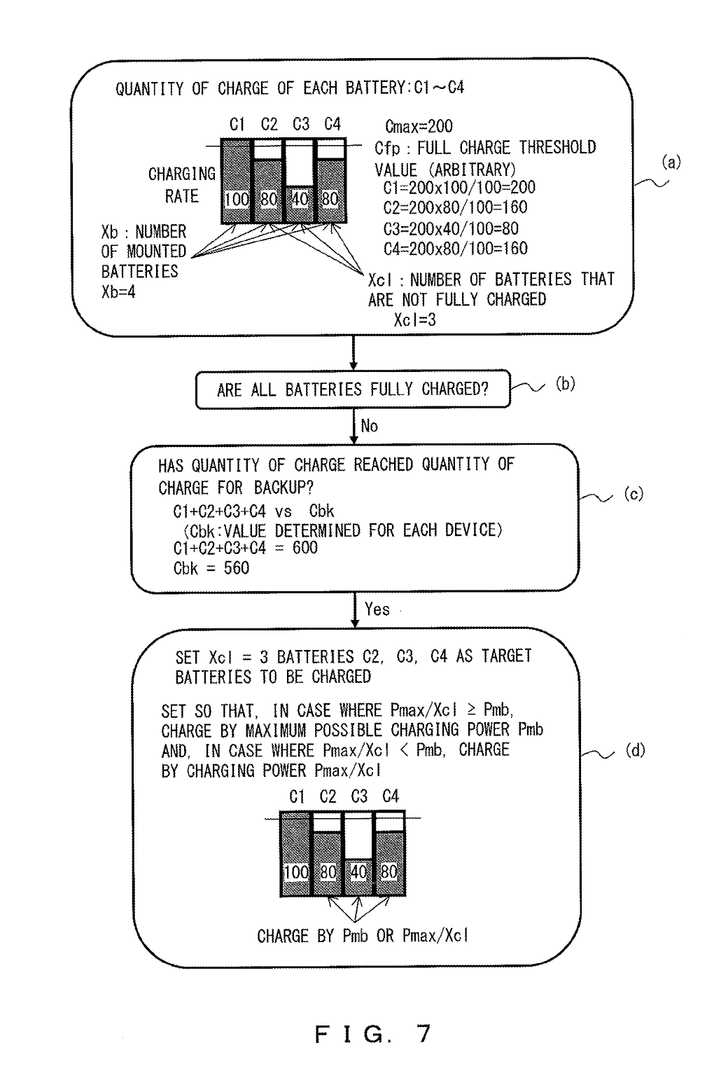

With reference to FIG. 7, a second embodiment is explained.

In the present embodiment also, the charging characteristics, i.e., the target battery and the charging power are set in the variable type, as in the first embodiment.

As in (a) in FIG. 7, it is assumed that there are four batteries 1 to 4. In other words, if the number of mounted batteries is denoted by Xb (sometimes written as Xmax as described above), Xb=4.

The present embodiment is an example of the charging method in the case where the sum of the quantities of charge of the four batteries reaches the quantity of charge for backup.

The quantity of charge or the state of charge of each of the four batteries is measured as in the processing at step S100 in FIG. 5A. It is assumed that the results of the measurement are C1=100%, C2=80%, C3=40%, and C4=80%, where C1, C2, C3, and C4 are the states of charge of the four batteries 1 to 4, respectively.

It is assumed that the quantity of charge Cmax of each battery in the fully charged state is 200 mAh. Of course, it may also be possible to use batteries having another rating.

At this time, the quantities of charge of the four batteries are as follows.

Battery 1: C1=200 [mAh]×100/100 [%]=200 [mAh]

Battery 2: C2=200 [mAh]×80/100 [%]=160 [mAh]

Battery 3: C3=200 [mAh]×40/100 [%]=80 [mAh]

Battery 4: C4=200 [mAh]×80/100 [%]=160 [mAh]

In (b) in FIG. 7, whether all of the batteries are fully charged is determined as in the processing at step S104 in FIG. 5A. In the case where all of the batteries are fully charged, the charging control processing is terminated. If the full-charge threshold value Cfp is assumed to be 92%, only the battery 1 reaches the full-charge level and the number of batteries whose state of charge does not exceed the full-charge threshold value Cfp is three, i.e., the batteries 2 to 4, and therefore, the number Xcl of batteries that are not fully charged is three, i.e., Xcl=3.

Next, in (c) in FIG. 7, whether the sum of the quantities of charge of the four batteries reaches the quantity of charge for backup Cbk is determined as in the processing at step S110 in FIG. 5A. Here, if the quantity of charge for backup Cbk is assumed to be 560, C1+C2+C3+C4=600, and therefore, the sum of the quantities of charge of the four batteries reaches the quantity of charge for backup Cbk, and therefore, it will be determined that C1+C2+C3+C4≧Cbk.

In (d) in FIG. 7, as in the processing at step S132 in FIG. 5B, the Xcl=3 batteries, i.e., the batteries 2 to 4 are set as the target batteries and the setting is performed so that in the case where Pmax/Xcl Pmb, charging is performed at the charging power Pmb, and in the case where Pmax/Xcl<Pmb, charging is performed at the charging power Pmax/Xcl.

After the target batteries and the charging power are set, the selected target batteries are charged by the set charging power. By adopting the charging method as described above, in the case where only some batteries need charging, such as in the case where some batteries are replaced with new ones, by performing control so as to bring the value of the charging current that is supplied to the battery that needs charging as close as possible to the maximum current that the power source can supply within a range of power that the battery can receive, it is possible to improve the charging efficiency, such as a reduction in the charging time.

Further, by using the charging method as described above in the information processing device, such as the storage device and the server, it is possible to obtain an information processing device having a high reliability.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a plurality of batteries;
a power source that charges the plurality of batteries;
a sensor that obtains a quantity of charge of each of the plurality of batteries and a total sum of the quantities of charge of the plurality of batteries; and
a processor that:
determines a charging candidate battery, which is a battery that needs charging, from among the plurality of batteries and the number of charging candidate batteries on the basis of the quantity of charge of each of the plurality of batteries and the total sum of the quantities of charge of the plurality of batteries, both of which are obtained by the sensor;
determines a set of a target battery that is a battery to be charged and charging power so that the charging candidate battery is charged by using one of a value obtained by dividing maximum suppliable power which the power source can supply by the number of charging candidate batteries, and maximum receivable power which the charging candidate battery can receive, whichever is smaller, as the charging power; and
controls the determined target battery to be charged by the charging power by using the power source.

2. The information processing device according to claim 1, wherein
the processor:
determines a battery that is not in a fully charged state from among the plurality of batteries and the number of batteries that are not in the fully charged state;
determines a battery whose quantity of charge does not reach a base quantity of charge and the number batteries whose quantity of charge does not reach the base quantity of charge; and
determines the target battery on the basis of a comparison between a value obtained by dividing the maximum suppliable power by the number of batteries that are not in the fully charged state, and a value obtained by dividing the maximum suppliable power by the number of batteries whose quantity of charge does not reach the base quantity of charge.

3. The information processing device according to claim 1, wherein
the processor:
calculates a base quantity of charge that each battery preferably stores in order to operate the information processing device by using the plurality of batteries; and
determines the set of the target battery and the charging power so that the batteries whose quantity of charge does not reach the base quantity of charge are charged by using charging power that is power of one of a value obtained by dividing the maximum suppliable power by the number of batteries whose quantity of charge does not reach the base quantity of charge, and maximum receivable power which the battery can receive, whichever is smaller, when the total sum of the quantities of charge of the plurality of batteries reaches the base quantity of charge.

4. The information processing device according to claim 1, wherein
the processor resets the set of the target battery and the charging power when a battery has newly entered a fully charged state after charging is started.

5. The information processing device according to claim 1, wherein
the processor sets one of a value obtained by dividing the maximum suppliable power by the number of batteries that are not in a fully charged state, and a value obtained by dividing the maximum suppliable power by the number of batteries whose quantity of charge does not reach a base quantity of charge, whichever is greater, as the charging power.

6. A charging method for charging a plurality of batteries included in an information processing device by using a power source, the charging method comprising:
obtaining a quantity of charge of each of the plurality of batteries and a total sum of the quantities of charge of the plurality of batteries;
determining a charging candidate battery, which is a battery that needs charging from among the plurality of batteries, and the number of charging candidate batteries;
determining a set of a target battery that is a battery to be charged and charging power so that the charging candidate battery is charged by using one of a value obtained by dividing maximum suppliable power which the power source can supply by the number of charging candidate batteries, and maximum receivable power which the charging candidate battery can receive, whichever is smaller, as the charging power; and
controlling the target battery to be charged by the charging power by using the power source.

7. The charging method according to claim 6, further comprising:
determining a battery that is not in a fully charged state from among the plurality of batteries and the number of batteries that are not in the fully charged state; and
determining a battery whose quantity of charge does not reach a base quantity of charge and the number of batteries whose quantity of charge does not reach the base quantity of charge, wherein
the determining the set of the target battery and the charging power determines the target battery on a basis of a comparison between a value obtained by dividing the maximum suppliable power by the number of batteries that are not in the fully charged state, and a value obtained by dividing the maximum suppliable power by the number of batteries whose quantity of charge does not reach the base quantity of charge.

8. The charging method according to claim 6, further comprising:
calculating a base quantity of charge, which is the quantity of charge that each battery preferably stores in order to operate the information processing device by using the plurality of batteries, wherein
the determining the set of the target battery and the charging power determines the set of the target battery and the charging power so that the battery whose quantity of charge does not reach the base quantity of charge is charged by using the charging power that is one of a value obtained by dividing the maximum suppliable power by the number of batteries whose quantity of charge does not reach the base quantity of charge, and maximum receivable power which the battery can receive, whichever is smaller, when the total sum of the quantities of charge of the plurality of batteries reaches the base quantity of charge.

9. The charging method according to claim 6, further comprising:
resetting the set of the target battery and the charging power when a battery has newly entered a fully charged state after charging is started.

10. The charging method according to claim 6, wherein
one of a value obtained by dividing the maximum suppliable power by the number of batteries that are not in a fully charged state, and a value obtained by dividing the maximum suppliable power by the number of batteries whose quantity of charge does not reach a base quantity of charge, whichever is greater, is set as the charging power.
